(19) United States
(12) Patent Application Publication
(10) Pub. No.: US 2002/0143576 A1
(43) Pub. Date: Oct. 3, 2002

(54) Remote patient health management system

(76) Inventors: Rainer Nolvak, Tallinn (EE); Kristjan Port, Tallinn (EE)

Correspondence Address: Michael M. Murray, Esq., Milbank, Tweed, Hadley & McCloy, LLP, One Chase Manhattan Plaza, New York, NY, 10005-1413, US

(21) Appl. No.: 09/819,844

(22) Filed: Mar. 28, 2001

(51) Int. Cl. G06F 17/60

(52) U.S. Cl. 705/2

(57) ABSTRACT

A method and apparatus for remotely monitoring the health of a patient, the method comprising the steps of: using a remotely located data collection device, prompting a remotely located user to place each of a plurality of electrodes connected to the data collection device in predetermined locations on the user's body; causing the data collection device to read electrical data from the patient's body using the electrodes, transmitting the electrical data to a central location; and evaluating the electrical data at the central location to make a determination as to the health of the patient. The electrical data may correspond to ECG data (also known as EKG). The remote unit is preferably a handheld unit with electrodes built into the surface of the device. Thus, by merely grasping the device in a predetermined way, a remote users ECG is taken and transmitted to a medical facility, allowing for effective monitoring of such patients.

### FIELD OF THE INVENTION

The present invention relates generally to remote health monitoring systems and more specifically, to a system capable of managing the health care of ill patients as well as sustaining the well-being of healthy people.

### BACKGROUND OF THE INVENTION

The treatment of chronically ill patients accounts for approximately 80% of all U.S. health care expenditures. Much of these costs are associated with the need to hospitalize patients with diseases such as hypertension, cardiovascular disease and diabetes. Many of these hospitalizations are necessary because the patients have failed to properly follow the often complex treatment plans used to treat these illnesses. Further expense is incurred due to the need for doctors to carefully monitor such patients, necessitating frequent appointments and examinations.

The health care industry also devotes substantial resources to maintaining the health of individuals who are not ill. Early diagnosis of potential problems can often be critical to the patient's ultimate well-being, and can dramatically reduce the costs associated with treatment. People who carefully monitor their health and make healthy lifestyle choices are both more likely to live more rewarding lives, and to reduce the burden on the healthcare industry.

### SUMMARY OF THE INVENTION

In one aspect, the invention features a method for remotely monitoring the health of a patient comprising the steps of: using a remotely located data collection device, prompting a remotely located user to place each of a plurality of electrodes connected to the data collection device in predetermined locations on the user's body; causing the data collection device to read electrical data from the patient's body using the electrodes, transmitting the electrical data to a central location; and evaluating the electrical data at the central location to make a determination as to the health of the patient. The electrical data may correspond to ECG data (also known as EKG).

### BRIEF DESCRIPTION OF THE DRAWINGS

FIG. 1 is a block diagram of a first embodiment of the invention.

FIG. 2 is a block diagram of a remote unit shown in FIG. 1.

FIG. 3 is a block diagram of a user station shown in FIG. 1.

FIG. 4 is a front view of one example of a handheld user station.

### DETAILED DESCRIPTION OF THE PREFERRED EMBODIMENTS

Discussion of the Preferred System

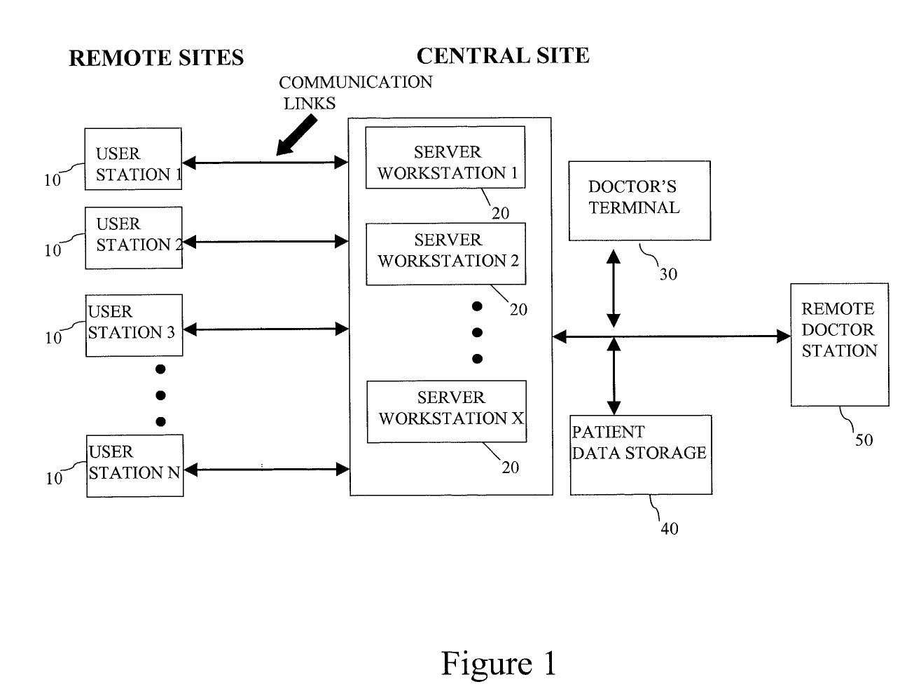

Referring to FIG. 1, the monitoring system of the present invention includes remote sites that contain a plurality of user stations 10. The user stations are placed in remote locations such as a patient's home, and are preferably portable handheld units, described further below. A central site features a plurality of workstations 20, one or more doctor terminal's 30 and one or more patient data storage facilities 40. A remote doctor station 50 is also provided and more than one such station may be used.

The communication links between the remote sites and the central station are flexible. Namely, each remote unit can be hooked to the central site, either in the home or when travelling, using any available communication channel, including, e.g., mobile phone, internet phone, ISDN, ASDL, etc. Usable communications protocols include all technologically available channels in addition to data (e.g. voice, video, multimedia, etc.).

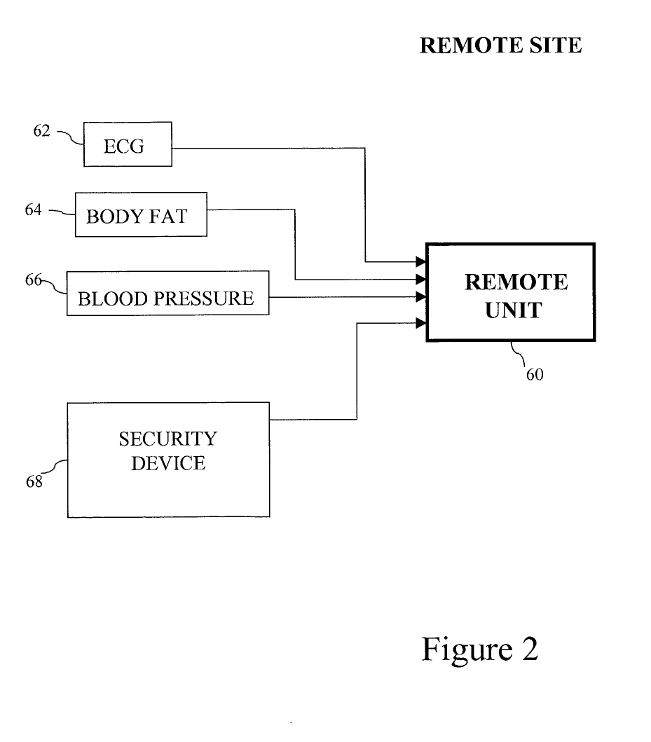

Referring to FIG. 2, each remote user station 10 includes a remote unit 60, and a plurality of body parameter measuring devices, such as ECG unit 62, body fat measuring unit 64, and blood pressure measuring unit 66. For identification purposes, the system includes a security device 68, such as a fingerprint scanner.

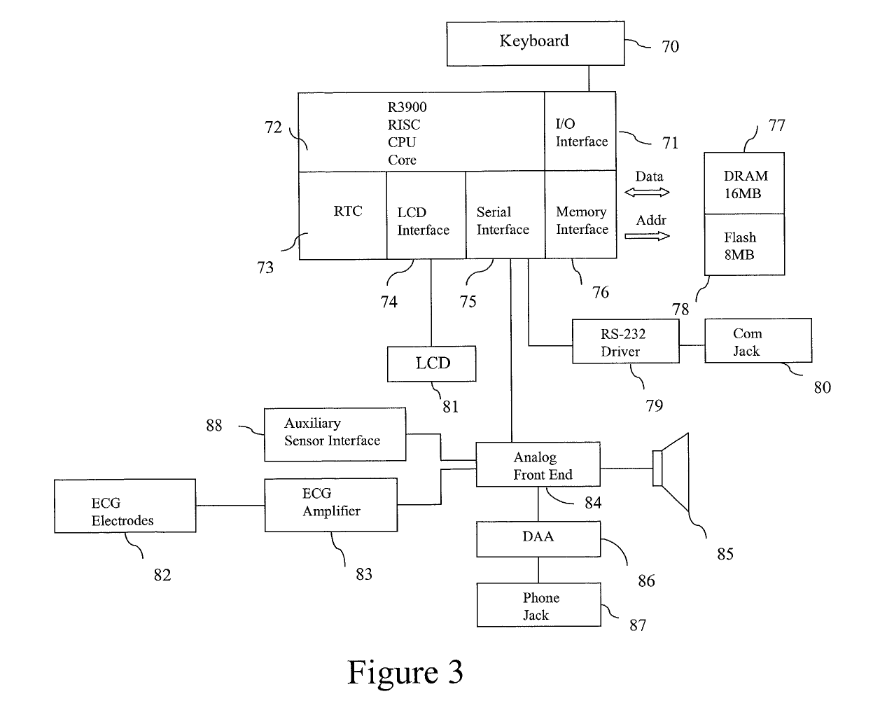

Referring to FIG. 3, each remote unit 60 includes a keyboard 70 connected to a RISC CPU Core 72 through an I/O interface 71. An RTC (i.e., real time clock) 73, LCD interface 74, serial interface 75 and memory interface 76 are also connected to CPU 72. Available memory includes DRAM 77 and flash memory 78.

Communications jack 80 is connected to serial interface 75 through an RS-232 driver 79. LCD 81 is connected to LCD interface 74.

ECG electrodes 82 are connected to ECG amplifier 83 which, in turn, is connected to an Analog Front End 84 (e.g., Philips UCB1200). In the preferred handheld unit, there are three ECG electrodes, one on each side of the unit and one on the back side such that when a user grips the unit he or she can place one thumb on one side electrode, can contact the electrode on the back of the unit with the palm or fingers, and can contact the third electrode with the other hand. An auxiliary sensor interface 88 provides an alternate input mechanism for ECG or other data. This interface can be any standard data interface, including a cable receptacle, an infrared port or a receiver for the well known Bluetooth™ connectivity protocol.

Analog Front End 84 drives a speaker 85 and is also connected both to serial interface 75 and to a D/A converter 86. Phone jack 87 is connected to D/A converter 86. Electrodes 82 may be spaced on opposite sides of the handheld device to allow the patient to place one hand on each electrode. The ECG data can therefore be measured from the signal across the patient's hands. Alternatively, the patient can use a traditional ECG set up with the electrodes placed on the chest in the standard positions. The data may then be fed into the unit.

Using this device, a digital channel is available through either corn jack 80 or an inbuilt wireless adapter, such as Bluetooth™.

Blood pressure unit 66 is a standard blood pressure device that can deliver the data to the remote unit using either a cable or a remote wireless adapter (e.g., Bluetooth™). The data can also be entered by the user via the keypad.

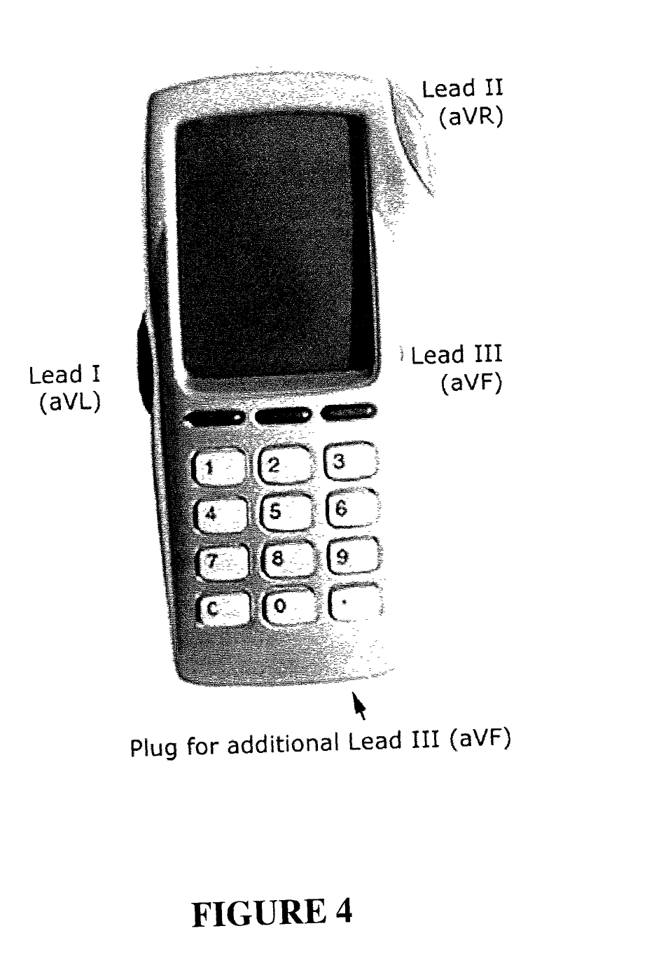

FIG. 4 shows one example of a handheld user station 10. As is described in more detail below, three electrodes, labeled Lead I, Lead II and Lead III are provided for ECG measurement. A plug for an alternative ECG lead is also provided.

Operation of the Preferred Embodiment

As noted above, the preferred embodiment of the invention features a system that includes remote monitoring units that can be used in patients' homes to provide a variety of functions. The remote units make medical technology once used exclusively in hospitals and doctors' offices available in the home. The system finds particular utility for those patients that require periodic medical surveillance.

The remote units collect patient data and forward it to a central site. Medically trained professionals at the central site monitor the patient data, significantly increasing the number of patients that can be cared for versus the traditional in-office doctor visits. In addition, medical records can be held at that central location allowing for an easier exchange of patient information amongst authorized medical personnel, resulting in faster and more accurate diagnosis of medical conditions.

Some of the conditions that can be monitored with the present invention are cardiovascular diseases such as hypertension, Chronic Heart Failure (CHF), arrhythmia, and ischemia. However, almost any bodily parameter that can be measured and converted to a signal can be monitored by the present invention and transmitted to a central station for data collection and observation.

In one aspect, the invention is a terminal-based device with a keyboard and LCD user interface screen, requiring less skill to operate than a standard personal computer. The units allow for the download of updated software in real time from the central site without trained personnel needing to visit the remote patient.

The transmission of data is preferably secured, i.e., encrypted (according to industry standard methodology) in order to protect the privacy of the patient.

Modular (script based) programming is preferred for the software used at the remote unit and central site. The scripts are not only questions for the user to answer, but contain fully functional applications. Scripts can include analytical tools to respond to user's entered data as well as queries or even multimedia instructions for educational purposes or as instructions. As a result, the user's terminal is remotely fully reconfigurable and alterable to adjust to any changes in the user's condition or requirements.

Accordingly, the patient can be monitored remotely using the script based programming. The system can automatically “question” a patient at preselected times and a physician or other health care professional (nurse, ambulance, etc.) is alerted if the patient's answers (or lack of answers) indicate a problem. For example, a patient with chronic heart disease might be asked if there is any numbness in the left arm or if there is any shortness of breath or tightness in the chest. As questions are asked, the patient inputs the answers on the keyboard and they are transmitted to and evaluated by the central site. Voice recognition may be used instead of a keyboard.

Every remote unit's software (scripts, drivers, etc.) and/or related parameters are updated according to the unique needs of the user. Part of the update information is originated from the caregiver while part of the update is done automatically from a central station for several purposes like supporting the unit's operations and feeding to it new information. For example, renewal and update of running software and/or hardware driver versions, time and calendar corrections, reports, etc. are done without direct involvement of either the doctor or patient.

Patient data trends can be analyzed by trained staff and modifications of the data set being measured and/or monitored can occur in real-time through the software updating process.

Another aspect of the preferred embodiment is the ability to provide the patient with feedback from the central site. Over time the patient has a benchmark or reference of his/her condition. This feedback is based on the doctor's (or nurse's) recommendations and remarks regarding treatment as well as on information generated from a rule based engine in the central site or locally by the remote unit's own script based software. The information includes doctor's recommendations, regular composite reports and indexes. The system opens a way for additional index like expression development with the aim to provide the user with an easily understandable and traceable health related compound denominator generated from the collected data to targeted information regarding knowledge about the patient's disease or special treatment program under way.

More specifically, a patients' bodily functions may be estimated by functional measurements to generate data describing conditions likely to adversely affect the long-term health. Rating such conditions enables the construction of numerical predictors and descriptors relating to health matters. For example—higher than normal blood pressure is considered as a health risk factor. Adding to the knowledge of the blood pressure data about body weight and daily stress level can establish a composite indicator of the patient's overall risk level. This risk level can be compared to the group of similar patient representatives or against the patient's own data over time.

Accordingly, trends in both healthy and unhealthy directions can be derived and be described in an easy and compact way. Recognition of such trends enables both the physicians and the patient's themselves to target prevention efforts more effectively. The system provides the means to develop and validate numerous indexes based on measured data and is not limited to any preset health index algorithm. The proposed indexes can be developed for a particular case (one patient with special health predicament) or for a group of patients. Also, already established indexes by third parties can be used like WHO risk factor analysis for cardiovascular risk etc.

In addition, more general information, such as local weather reports (pollen alerts, temperature, etc.), may be made available for the patient.

The preferred embodiment may also be used to provide data that is not directly related to health care. For example, the system provides the ability to order a hairdresser, social worker etc. In these cases there will be an update of information based on particulars of these services to be sent to the remote device. The patient is able to select from a list of third party services and customize the selection of services for a particular need.

As described in more detail below, the remote unit electrodes can be used to measure ECG data that can be transmitted to the central site. The cardiac signal can be registered in different ways. The preferred system features three physical electrodes (leads) and six logical electrodes. A first logical setup consists of three active bipolar electrodes. The patient is prompted to place his hands on the electrodes in a predefined way. This prompting can be instructions and/or a diagram displayed to the patient on the display. The monitoring could also simply be the unit giving an indication that it is on and is now ready to receive data (e.g., an “on” indicator or light).

Holding the remote unit in one hand, e.g., the left hand, the patient has contact with two electrodes, one on one side of the unit which contacts the thumb (“Lead I”) and the electrode on the back of the unit (“Lead III”) which contacts the palm or fingers. The patient then touches the other hand to the other side electrode (“Lead III”).

A triangle can be drawn between the three electrodes. This triangle is referred to as Einthoven's triangle in honor of Willem Einthoven, who developed the electrocardiogram in 1901. However, whereas a traditional Einthoven triangle is built around roughly forming equilateral triangle (with the heart at the center), in the situation of the preferred embodiment, Lead III has an asymmetrical position compared with Lead I and Lead II, thus, Forming asymmetrical feedback loop. The main purpose of Lead III is to sustain equiplanarity between Lead I and Lead II registrations through feedback. The data retrieved from Lead III is corrected to obtain symmetry. Alternatively, for the purpose of agreement with orthodox bipolar ECG measurements, a plug for the hookup of a separate Lead III is available. In such case, Lead III will be placed on the left leg and the Lead III on the unit's casing is decoupled.

Thus, by convention, Lead I has the positive electrode on the left arm, and the negative electrode on the right arm, and therefore measures the potential difference between the two arms. In certain embodiments of the present invention, the third electrode (Lead III) serves as the reference electrode for recording purposes, which conventionally is on the left leg. Thus, the third electrode in this embodiment (Lead III) has been risen from the leg to the left hand.

In the conventional Lead II configuration, the positive electrode is on the left leg (in our case on the left arm under thumb) and the negative electrode is on the right arm.

Whether the limb leads are attached to the end of the limb (wrists and ankles) or at the origin of the limb (shoulder or upper thigh) makes little difference in the recording of an ECG because the limb can simply be viewed as a long wire conductor originating from a point on the trunk of the body. In certain embodiments, we chose to use the palms as distal point on the upper limbs for the purpose of creating an easy and effortless access for the registration of ECG. This also serves the purpose of making ECG measurements practically available at all times, and is not dependent on the patient's location. For example, a patient can be anywhere (shopping mall, walking outside, being in public places etc.), and can quickly and easily take and transmit ECG data. The handheld unit can be equipped with standard cellular technology for immediate transmission of the ECG information, can be plugged into a telephone or other communications device, or can use other wireless transmission protocols.

The three bipolar limb leads described above can also be used as three augmented unipolar limb leads by multiplexing (switching) in time. These are termed unipolar leads because there is a single positive electrode that is referenced against a combination of the other limb electrodes. The positive electrodes for these augmented leads are located on the left arm (aVL) (e.g., under the thumb), the right arm (aVR), and the left leg (aVF) (e.g., on the left arm fingers). In practice, these are the same electrodes used for Leads I, II and III.

The three augmented unipolar leads, coupled with the three bipolar leads, constitute the six limb leads of the ECG. These leads record electrical activity along a single plane, termed the frontal plane relative to the heart. Using the axial reference system and these six leads, it is rather simple to define the direction of an electrical vector at any given instant in time. However, for the express diagnosis (i.e., not using the separate Lead III) the electrodes on the casing of the handheld unit do not provide readings exactly the same as traditional axes. Therefore, the user will be informed of the need of correct interpretations of the results when taking ECG data in this way.

Therefore, certain embodiments of the invention provide in addition to quick monitoring purposes also a setup for quick and effortless traditional ECG registrations involving 6 electrode setup is by using Lead III (aVF) through a separate wired hookup. In this case the corresponding lead on the unit's casing will be decoupled supporting the traditional Left arm—Right arm—Left leg model.

As noted above, two of the inbuilt electrodes (e.g., Leads I and II on the sides of the unit) measure the signal between the patient's hands, which is not the classical method of ECG measurement. However, the most important difference between this technique and the standard ECG technique lies in the amplitude characteristics of the generated signal. As the heart undergoes depolarization and repolarization, the electrical currents spread throughout the body because the body acts as a volume conductor. The electrical currents generated by the heart are commonly measured by an array of electrodes placed on the body surface. By convention, electrodes are placed on each arm and leg. The registered amplitude of the cardiac signal is dependent on the placement of the electrodes on the torso relative to the heart, including the distance from the heart, skin conductivity in the place of contact and changes in impedance when the patient is moving. This state of affairs is common to ECG measurement in general, including both classical ECG measurements and the more convenient measurements using the above-described embodiment of the invention. With this embodiment, the resulting ECG amplitude at the equivalent instant in time compared to traditional signal at the same time may or may not have the same magnitude. The length of the limb where measurement is performed is basically regarded as wire conductor from the heart—consequently the registered amplitude may be different. However, the measured signal is the same and a cardiologist is able to diagnose the patient knowing the placement of the electrodes during measurement. Thus, the technique described herein varies from classical only in the sense of the placement of the electrodes. Accordingly, even though this embodiment of the invention can use only the hands for an ECG measurement, the signal is as informative as a traditional ECG signal. The medical personnel involved in reading the ECG are preferably informed of the placement of the electrodes.

What are identical with the established ECG standard are the time dependent signal movements. Therefore, the following parameters are available for measurement using this technique: heart rate, RR interval, PQ interval, P wave interval, QRS interval, U wave interval, QT interval, T wave interval, P wave amplitude, Q wave amplitude, R wave amplitude, S wave amplitude, T wave amplitude, ST segment elevation/depression, supraventricular and ventricular arrhythmia.

Moreover, as noted above, the remote unit can receive standard ECG signals through wireless interface to an orthodox ECG measurement setup using a wearable attachment.

The remote unit can also use a superficial electrode based measurement for alternate index of large artery stiffness that is an independent predictor of cardiovascular risk (presence of arteriosclerosis). For the measurement of large artery stiffness the value of pulse wave velocity is measured as a function of the ECG signal. This signal is set off the contraction of the heart and registration of the travel time of the pulse wave on the limb. The threshold of the pulse wave is measured by registering impedance changes in the blood transit passageway. This new technique of artery stiffness measurement complements the conventional blood pressure measurements and provides additional information on cardiac function. The measurement is done between limbs registering volume impedance in the segment of registration Z₀ and change in impedance ΔZ resulting from a cardiac cycle. Two main arrangements are preferable: between hands and between hand and opposite leg (e.g. left hand and right leg). Holding the unit in one hand (preferably the left hand) two ECG electrodes (Lead I and Lead III) will be switched for the hand contact. Hookup electrode (additional electrode replicating Lead III hooked through a plug) and Lead II will be placed on the leg electrodes opposing each other across the measurement point to allow impedance measurement over the limb volume between the electrodes.

As a result, we can register through the ECG electrodes on the hand and leg (Leads I-II-III) an initial set off signal indicating the start of the cardiac cycle and multiplexing (in time and/or frequency) the same electrodes for the impedance measurement, the system will register the change in impedance caused in the distal end of the limb by pulse wave initiated volume change in blood vessels. The time between the start of a cardiac cycle and the front of impedance change on the limb characterizes the speed of movement of the pulse wave. Consequently, knowing the distance one can estimate the speed of the pulse wave, which is a clinical measurement of arterial stiffness linked to the presence of arteriosclerosis.

Several consecutive cardiac cycles are registered and a statistically cleaned and resulting value is used for the indication. Preferably two separate frequencies (near 30 kHz and 300 KHz correspondingly) are used to calculate different volume constituents to form the ultimate measurement. The system can also register the characteristic body impedance change during a cardiac cycle (ΔZ over time). Using time overlay by multiplexing electrodes for the two registrations, namely ECG and change in bioimpedance over time, the preferred embodiment enables comparison of two consecutive graphs. ECG will display electrical impulse related information in the myocardium while the bioimpedance derived graph displays information about the cardiac pumping function. Both realms will increase information content of the registrations and serve both doctor and patient by increasing the quality of the diagnosis and the cure.

Another aspect of the preferred embodiment is the fitness monitoring of healthy people leading active lifestyles. Several case specific fitness programs are available starting from basic step-test for cardiovascular functionality measurement through more complex setups including walking, running and other activities. All tests may be instruction based, e.g. user's unit displays all relevant guidelines and signals for time-dependent marks. In one example, the unit gives specific instructions to the user, such as, do 15 jumping jacks. The user does the jumping jacks while holding the handheld unit. The unit can measure body parameters, including ECG or pulse rate, while the exercise is being carried out. The unit continues to give instructions, taking the user through a complete exercise routine. Feedback is provided to the user based on how well the user's body handles the exercise.

Body fat is measured using a conventional bioimpedance method. The multiplexing modality also applies here. However, instead of registering ECG and impedance transformations in the distal end of a limb, a whole body impedance (Z₀ and change in the whole body impedance ΔZ resulting from a cardiac cycle) may be registered. Thus, the unit of the preferred embodiment provides the means to measure body fat at the same instance as a patient is registering their ECG. Body water content may also be registered within the body fat measurement procedure using at least two different frequencies during impedance measurement. Adding this feature to the complex of cardiac registrations allows characterizing patients dehydration/rehydration status. Patients with CHF are extremely prone to impairment of extra cellular fluid metabolism. The body water content will serve as a very useful indicator for the correct diagnosis and for the rehabilitation advice generation. Furthermore, knowing the body water content is a good indicator of general blood viscosity, the increase of which will raise workload on the heart and impairs blood supply to the peripheral parts of the body.

Another aspect of the invention is the ability to provide health forecasting. A set of developed rules are used for risk prediction and/or bodily function development. Several rules and indexes are well known particularly in the field of risk factor analysis. For example, the measurement of daily weight dynamics against cardiovascular data (ECG, blood pressure, fitness test etc.) gives an indication of the progress of the patient.

The above description is by way of example only and it will be readily apparent to those of skill in the art that many modifications may be made within the spirit of the invention and that many other embodiments are included as part of this invention.

1. A method for remotely monitoring the health of a patient, said method comprising:
using a remotely located data collection device, prompting a remotely located user to place a plurality of electrodes connected to said data collection device in predetermined locations on the user's body;
causing said data collection device to read electrical data from the patient's body using said electrodes,
transmitting said electrical data to a central location; and
evaluating said electrical data at said central location to make a determination as to the health of the patient.

2. The method of claim 1 wherein said electrical data corresponds to ECG data.

3. The method of claim 1 wherein said plurality of electrodes comprises three electrodes.

4. The method of claim 1 wherein said data collection device is a hand-held device and said plurality of electrodes are in predetermined locations on the surface of said hand-held device.

5. The method of claim 1 further comprising the step of transmitting evaluation data from said central location to said data collection device to provide feedback to the patient.

6. The method of claim 1 wherein said data collection device comprises a display to display information to the patient.

7. The method of claim 1 further comprising the steps of:
receiving, at said data collection device, data obtained from a measuring device, and
transmitting said received data to the central location.

8. The method according to claim 7 wherein the data collection device is a blood pressure measurement device.
